(19) United States
(12) Patent Application Publication
(10) Pub. No.: US 2024/0353224 A1
(43) Pub. Date: Oct. 24, 2024

(54) SHAPE ACQUISITION METHOD, OBJECT MANAGEMENT METHOD, WORK SUPPORT METHOD, SHAPE ACQUISITION SYSTEM, AND WORK SUPPORT SYSTEM

(71) Applicant: NIKON CORPORATION, Tokyo (JP)

(72) Inventor: Takashi MIYAWAKI, Machida-shi (JP)

(73) Assignee: NIKON CORPORATION, Tokyo (JP)

(21) Appl. No.: 18/701,514

(22) PCT Filed: Oct. 25, 2022
(86) PCT No.: PCT/JP2022/039727

§ 371 Date: Apr. 15, 2024

(30) Foreign Application Priority Data
Oct. 28, 2021 (JP) 2021-176498

(51) Int. Cl. G01B 21/32; E02D 17/04

(52) U.S. Cl. CPC G01B 21/32; E02D 17/04

(57) ABSTRACT

A shape acquisition method includes acquiring information of a tilt angle of one surface of a target object at each of a plurality of measurement points on the surface using a plurality of sensors (Step S1) and calculating a shape of the surface of the target object through an arithmetic operation including function fitting using a discrete distribution of a physical quantity associated with the acquired information of the tilt angle (Step S2). Accordingly, it is possible to accurately perform areal evaluation in measurement management of the target object.

### TECHNICAL FIELD

The present invention relates to a shape acquisition method, an object management method, a work support method, a shape acquisition system, and a work support system, and more particularly to a shape acquisition method, a shape acquisition system, an object management method, and a work support method and a work support system using the shape acquisition method that are suitable, for example, when at least a part of a structure (also referred to as a structure or the like) constructed at a work site of construction such as earth retaining construction, bridge construction, or base frame construction is a target object.

Priority is claimed on Japanese Patent Application No. 2021-176498, filed Oct. 28, 2021, the content of which is incorporated herein by reference.

### BACKGROUND ART

In earth retaining construction, in order to secure safety and economic feasibility, it is necessary to perform various types of measurement at a construction site and to ascertain a current state of an earth retaining structure on the basis of the measured values. In measurement management of earth retaining construction in the related art, measurement of a depth distribution of horizontal displacement using a clinometer or the like is performed. However, with the method according to the related art, only dotted or areal and local measurement data is acquired, and it is difficult to ascertain overall behavior of an earth retaining wall.

In consideration of the aforementioned circumstances, inventions of a measurement system and a measurement method that can perform areal evaluation on measurement management of an earth retaining wall have recently been proposed (for example, see Patent Document 1). In the invention described in Patent Document 1, since a plurality of clinometers are two-dimensionally arranged, the areal evaluation is considered to be performed on the basis of measured values of the clinometers.

However, in the invention described in Patent Document 1, since the measured values of the clinometers are simply processed using simple geometric methods, it cannot be said that overall behavior of the earth retaining wall is ascertained with sufficiently high accuracy, and thus there is room for improvement or enhancement.

### CITATION LIST

### Patent Document

[Patent Document 1]
Japanese Patent Application, Publication No. 2019-52467

### SUMMARY OF INVENTION

### Solution to Problem

As a shape acquisition method of acquiring shape information of a target object according to a first aspect of the present invention, there is provided a shape acquisition method including: acquiring information of a tilt angle of a measurement surface of the target object at a plurality of measurement points using a plurality of sensor devices respectively, positions of the measurement points being different in one of two directions crossing each other in the measurement surface; and acquiring a shape of the measurement surface represented by a predetermined polynomial function as the shape information of the target object, the polynomial function including coefficients of terms calculated by fitting a discrete distribution of a physical quantity associated with the tilt angle calculated on the basis of the acquired information of the tilt angle at the plurality of measurement points and position information of the plurality of measurement points to the polynomial function.

In this specification, “shape information” is a concept including information on change of a shape with time, a spatial distribution of deformation, and the like in addition to a shape of a target object.

As an object management method according to a second aspect of the present invention, there is provided an object management method including: repeatedly performing the shape acquisition method according to the first aspect; and monitoring change of a shape of the target object with time on the basis of the shape information acquired whenever the shape acquisition method is performed.

As an object management method according to a third aspect of the present invention, there is provided an object management method including: performing the shape acquisition method according to the first aspect at a first time point and a second time point later than the first time point; and identifying a position at which an amount of deformation of the measurement surface of the target object is greater than a predetermined allowable value on the basis of amounts of change of the coefficients of the terms of the polynomial function acquired at the time points.

As an object management method of maintaining deformation of a target object in a desired state according to a fourth aspect of the present invention, there is provided an object management method including: preparing a database storing data of a matrix, including setting a plurality of states in which a bearing force with a predetermined magnitude is additionally applied to only an identified one out of a plurality of support members in a reference state in which the target object is supported by the plurality of support members such that an amount of deformation of a measurement surface is equal to or less than an allowable value while changing the identified support member, and repeatedly performing the shape acquisition method according to the first aspect for each of the plurality of states, the matrix having, as elements, amounts of change of the coefficients of the terms in a predetermined polynomial function from the reference state corresponding to change of the measurement surface from the reference state due to application of the bearing force to the identified support member in the plurality of states acquired whenever the shape acquisition method is performed; acquiring a first column matrix having, as elements, the amounts of change of the coefficients of the terms in the polynomial function from the reference state corresponding to change of the measurement surface from the reference state in an arbitrary state after the reference state; and determining the magnitude of the bearing force to be applied to the support members by solving an equation representing that the first column matrix is equal to a product of the matrix and a second column matrix having, as elements, bearing forces to be applied to the plurality of support members.

Here, maintaining deformation of a target object in a desired state includes maintaining deformation of the target object in a state within an allowable error range.

As a work support method of supporting object construction work according to a fifth aspect of the present invention, there is provided a work support method including: acquiring shape information of a measurement surface of a target object at one or more time points including a first time point using the shape acquisition method according to the first aspect; and performing at least one of sensing an abnormality in the target object, determining a bearing force of a support member supporting the target object, and preparing/proposing a work procedure on the basis of the acquired shape information.

As a shape acquisition system for acquiring shape information of a target object according to a sixth aspect of the present invention, there is provided a shape acquisition system including an analysis device and a plurality of sensor devices which are connected to each other via a network, wherein the plurality of sensor devices measure a tilt angle of a measurement surface of the target object at a plurality of measurement points respectively, positions of the measurement points being different in one of two directions crossing each other in the measurement surface and output a plurality of pieces of sensor data including information of the tilt angles to the analysis device via the network, and the analysis device receives the plurality of pieces of sensor data via the network, calculates a discrete distribution of a physical quantity associated with the tilt angles on the basis of information of the tilt angles included in the plurality of pieces of sensor data and position information of the plurality of measurement points, calculates coefficients of terms in a predetermined polynomial function by fitting the discrete distribution to the polynomial function, and stores a shape of the measurement surface represented by a polynomial function including the calculated coefficients as definitive coefficients of the terms in a storage.

As a shape acquisition system for acquiring shape information of a target object according to a seventh aspect of the present invention, there is provided a shape acquisition system including an analysis device and a plurality of sensor devices which are connected to each other via a network, wherein the plurality of sensor devices measure a tilt angle of a measurement surface of the target object at a plurality of measurement points of which positions are different in one of two directions crossing each other in the measurement surface and output a plurality of pieces of sensor data including information of the tilt angles to the analysis device via the network, outputting of the plurality of pieces of sensor data from the plurality of sensor devices to the analysis device via the network is performed at a first time point and a second time point later than the first time point, and when the plurality of pieces of sensor data are received via the network, the analysis device repeatedly performs calculating a discrete distribution of a physical quantity associated with the tilt angles on the basis of information of the tilt angles included in the plurality of pieces of sensor data and position information of the plurality of measurement points, calculating the coefficients of the terms in a predetermined polynomial function by fitting the discrete distribution to the polynomial function, and acquiring the shape of the measurement surface represented by the polynomial function including the calculated coefficients as definitive coefficients of the terms and identifies a position at which an amount of deformation of the target object is greater than a predetermined allowable value on the basis of a magnitude relationship between the coefficients of the terms in the polynomial function acquired at the time points.

As a shape acquisition system for acquiring shape information of a target object according to an eighth aspect of the present invention, there is provided a shape acquisition system including an analysis device and a plurality of sensor devices which are connected to each other via a network, wherein the plurality of sensor devices measure a tilt angle of a measurement surface of the target object at a plurality of measurement points of which positions are different in one of two directions crossing each other in the measurement surface and output a plurality of pieces of sensor data including information of the tilt angles to the analysis device via the network, a plurality of states in which a bearing force with a predetermined magnitude is additionally applied to only a specific one out of a plurality of support members in a reference state in which the target object is supported by the plurality of support members such that an amount of deformation of the measurement surface is equal to or less than an allowable value are set while changing the identified support member, and outputting of the plurality of pieces of sensor data from the plurality of sensor devices to the analysis device via the network is repeatedly performed for the plurality of states, and the analysis device has: a first function of preparing a database including data of a matrix, including, when the plurality of pieces of sensor data are received via the network, calculating a discrete distribution of a physical quantity associated with the tilt angles on the basis of information of the tilt angles included in the plurality of pieces of sensor data and position information of the plurality of measurement points, calculating coefficients of terms in a predetermined polynomial function by fitting the discrete distribution to the polynomial function, acquiring a shape of the measurement surface represented by a polynomial function including the calculated coefficients as definitive coefficients of the terms, the matrix having, as elements, amounts of change of the coefficients of the terms in the polynomial function from the reference state corresponding to change of the measurement surface from the reference state due to application of the bearing force to the identified support member in the plurality of states; a second function of acquiring a first column matrix having, as elements, the amounts of change of the coefficients of the terms in the polynomial function from the reference state corresponding to change of the measurement surface from the reference state in an arbitrary state after the reference state; and a third function of determining the magnitudes of the bearing forces to be applied to the support members by solving an equation representing that the first column matrix is equal to a product of the matrix and a second column matrix having, as elements, bearing forces to be applied to the plurality of support members.

As a work support system for supporting work of constructing a target object according to a ninth aspect of the present invention, there is provided a work support system including an analysis device and a plurality of sensor devices which are connected to each other via a network, wherein the plurality of sensor devices measure a tilt angle of a measurement surface of the target object at a plurality of measurement points of which positions are different in one of two directions crossing each other in the measurement surface and output a plurality of pieces of sensor data including information of the tilt angles to the analysis device via the network, the analysis device receives the plurality of pieces of sensor data via the network, calculates a discrete distribution of a physical quantity associated with the tilt angles on the basis of information of the tilt angles included in the plurality of pieces of sensor data and position information of the plurality of measurement points, calculates coefficients of terms in a predetermined polynomial function by fitting the discrete distribution to the polynomial function, and acquires information of a shape of the measurement surface represented by a polynomial function including the calculated coefficients as definitive coefficients of the terms, and the analysis device performs acquiring the information of a shape at one or more time points including a first time point and performs at least one of sensing an abnormality in the target object, determining a bearing force of a support member supporting the target object, and preparing/proposing a work procedure.

### BRIEF DESCRIPTION OF DRAWINGS

FIG. 1 is a diagram schematically illustrating the entire configuration of a shape acquisition system according to an embodiment for realizing a shape acquisition method.

FIG. 2 is a block diagram illustrating an example of a configuration of a sensor device illustrated in FIG. 1.

FIG. 3 is a perspective view in which a part of a side wall of an underground space which will eventually become an underground room and which includes an earth retaining wall which is a target object in shape measurement is omitted.

FIG. 4 is a diagram illustrating a simplified extracted soil-cement column-array wall and illustrating measurement with an earth retaining wall as a target object.

FIG. 5 is a flowchart illustrating a process flow of a shape acquisition method according to the embodiment.

Part (A) of FIG. 6 is a diagram illustrating a measurement surface in a three-dimensional orthogonal coordinate system (x, y, z) and part (B) of FIG. 6 is a diagram illustrating the measurement surface in a polar coordinate system (x=ρ cos θ, y=ρ sin θ).

FIG. 7 is a flowchart illustrating a process algorithm that is performed by a CPU of an arithmetic processing unit of each sensor device.

FIG. 8 is a flowchart illustrating a process algorithm of an interruption process routine that is performed by a CPU of a server and that is used in the process of Step S2.

FIG. 9 is a diagram illustrating components of the first several terms of a Zernike polynomial of Expression (1) in a shaded pattern in unit circles in the polar coordinate system (ρ, 0).

FIG. 10 is a flowchart illustrating a process algorithm that is performed by the server when a dedicated database for realizing optimal support using struts is prepared.

FIG. 11 is a flowchart illustrating an interruption process routine that is performed by the server 12 when optimal adjustment of an axial force of a strut supporting a target object (a wall) is performed.

### DESCRIPTION OF EMBODIMENTS

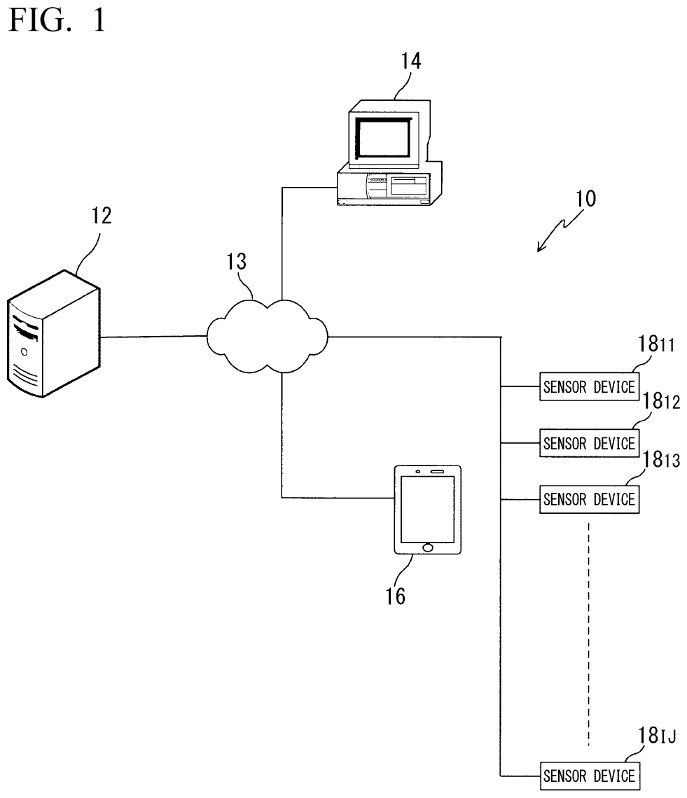

Hereinafter, an embodiment will be described with reference to FIGS. 1 to 11. Here, for example, it is assumed that a target object is an earth retaining wall, but the target object is not limited to an earth retaining wall. An “earth retaining wall” in this embodiment is a partition for protecting an excavated side surface, preventing a landslide or spring water, or securing safety of another nearby structure at the time of excavation in the ground. An earth retaining wall may also be referred to as a retaining wall. “Excavation” means that earth or rock under the ground surface is excavated to construct a foundation or an underground structure.

Examples of the earth retaining wall include a soil-cement column-array wall, a soldier-pile horizontal sheathing wall, a steel sheet pile wall, and a steel pipe sheet pile wall. Among these, it is assumed in this embodiment that a target object is a soil-cement column-array wall. The soil-cement column-array wall is a wall constructed in the ground out of core members (for example, H-shaped steel beams or I-shaped steel beams) and concrete (cement milk). In an earth retaining wall, a “core member” is a member that is a part of the earth retaining wall and shares a bearing force, and examples thereof include an H-shaped steel beam, a steel sheet pile, a steel pipe sheet pile, and a secondary concrete product.

FIG. 1 schematically illustrates the entire configuration of a shape acquisition system 10 according to an embodiment for realizing a shape acquisition method. The shape acquisition system 10 includes a server 12 also serving as an analysis device, a field-side computer 14 and a mobile terminal 16, and a plurality of sensor devices 18ᵢⱼ (where i=1, 2, 3, . . . I and j=1, 2, 3, . . . . J) which are connected to each other via a wide area network 13 such as the Internet. The total number of sensor devices is set to I×J=K. The plurality of sensor devices 18ᵢⱼ are connected to the wide area network 13 via a communication line, for example, a wireless LAN.

The communication line can be considered to be a part of a network including the wide area network 13, and thus this network is referred to as a network 13 using the same reference sign as the wide area network. The whole communication line may be wireless, or at least a part thereof may be wired.

The field-side computer 14 may be a general desktop personal computer (PC), a notebook PC, a tablet PC, a mobile PC, or a smartphone.

The mobile terminal 16 is carried by a field worker. The mobile terminal 16 is a portable computer which is generally used, for example, a tablet PC. The mobile terminal 16 may be a smartphone.

Instead of providing outputs of a plurality of sensor devices 18ᵢⱼ to the server 12 via the network, the outputs may be provided to the server 12 via the field-side computer 14 and the network 13. The field-side computer 14 is not necessarily provided, and the mobile terminal 16 may also serve as the field-side computer. Transmission and reception of information between a plurality of sensor devices 18ᵢⱼ and the server 12 may be performed via another terminal device connected to the network 13.

The plurality of sensor devices 18ᵢⱼ are disposed on an earth retaining wall including a soil-cement column-array wall which is a target object with a predetermined positional relationship, and arrangement of the sensor devices 18ᵢⱼ will be described in detail later.

In this embodiment, a server computer which is generally used is used as the server 12, but a cloud (computer) may be used. The server 12 includes a CPU, a ROM, a RAM, and an HDD (storage) which are not illustrated, and the CPU executes various process algorithms which are defined by various programs stored in the ROM, the HDD, or the like, for example, using the RAM as a work area. The configuration of the server 12 also serving as an analysis device is not limited to this embodiment as long as it has a configuration (or a function) of shape information of a target object (an earth retaining wall) through an arithmetic operation on the basis of the outputs of the plurality of sensor devices 18ᵢⱼ. The analysis device is not limited to hardware as in this embodiment, but may be, for example, software that can perform at least an arithmetic function.

When sensor data (which includes IDs) is received via the network 13 as will be described later, the server 12 performs an interruption process routine which will be described later and acquires information of a shape of one surface of a target object (a measurement target) as shape information. Details of the interruption process routine will be described later.

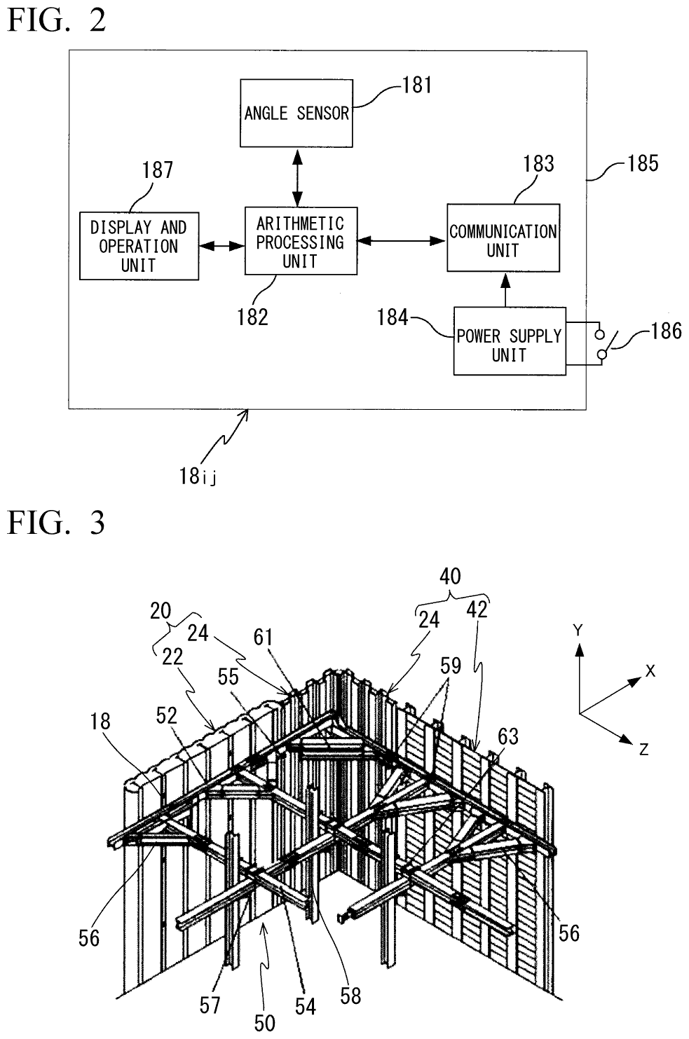

As illustrated in FIG. 2, each of the sensor devices 18ᵢⱼ includes an angle sensor 181, an arithmetic processing unit 182, a communication unit 183, a power supply unit 184 constituted by, for example, a battery, and a waterproof housing 185 accommodating these therein. Supply of electric power from the power supply unit 184 to the constituents of the sensor device 18ᵢⱼ can be turned on and off by operating a power supply switch 186 provided in the housing 185. The sensor device 18ᵢⱼ further includes a display and operation unit 187 constituted by, for example, a small touch panel. The display and operation unit 187 is connected to the arithmetic processing unit 182 and serves as both an input device and a display device. A part of the display and operation unit 187 is exposed from the surface of the housing 185. The communication unit 183 is constituted by a wireless communication unit that performs wireless communication in this embodiment, but the communication unit 183 is not limited to wireless and at least a part thereof may be wired. The sensor device 18ᵢⱼ does not have to include the power supply switch 186, and a power supply thereof may be turned on and off through an operation from the outside (such as the server 12 or the mobile terminal 16). The sensor device 18ᵢⱼ is not limited to the configuration of this embodiment, and the angle sensor 181, the communication unit 183, and the like may be provided as a non-unified body as long as the sensor device 18ᵢⱼ has at least a function of the angle sensor 181, that is, a function of measuring angle information at a position at which the sensor device 18ᵢⱼ is installed. For example, the angle sensor 181 and the other constituents (which include the arithmetic processing unit 182) may be connected by a wireless or wired communication line, and outputting of sensor data from the angle sensor 181 and supply of electric power to the angle sensor 181 may be performed via the communication line. In this case, the other constituents do not have to be provided for each angle sensor 181, and a plurality of angle sensors 181 may be connected to the same other constituents via the communication line. The functions of the other constituents may be provided in another terminal device or the like connected to the network 13.

As the angle sensor 181, for example, a three-dimensional micro electromechanical system (3D MEMS) tilt angle sensor is used in this embodiment. The 3D MEMS tilt angle sensor is a precise tilt sensor which is manufactured using 3D MEMS technology. Electric power required for the 3D MEMS tilt angle sensor is power consumption which is very low and which is in a microampere range, and the 3D MEMS tilt angle sensor is suitable for wireless applications. For example, a sensor in which two MEMS acceleration sensors of which output characteristics are symmetric and an ASIC are provided is used as the angle sensor 181, and information of, for example, tilt angles (α, β, and γ) in three directions (a θx direction, a θy direction, and a θz direction) is output therefrom. Here, the θx direction, the θy direction, and the θz direction are tilt/rotation directions about an X axis, a Y axis, and a Z axis in a three-dimensional orthogonal coordinate system illustrated in FIG. 3.

The angle sensor is not limited to a 3D MEMS tilt angle sensor, and another type of three-dimensional tilt angle sensor may be used. According to a measurement target, the angle sensor is not limited to a three-dimensional tilt angle sensor, and a two-dimensional tilt angle sensor or a one-dimensional tilt angle sensor may be used. At this time, a two-dimensional tilt angle sensor and a one-dimensional tilt angle sensor may be combined, or a plurality of two-dimensional or one-dimensional tilt angle sensors may be combined.

The arithmetic processing unit 182 is constituted by, for example, a micro controller (MCU) and includes a CPU, a memory device (such as a RAM or a ROM), an input and output circuit, and a timer circuit which are not illustrated. The arithmetic processing unit 182 performs a process algorithm which is defined by programs stored in the ROM. Instead of providing the arithmetic processing unit 182, the function of the arithmetic processing unit 182 may be provided in an ASIC built in the angle sensor 181.

Here, various types of means corresponding to types of target objects can be employed as a means for installing the sensor device 18ᵢⱼ in a target object. For example, when a target object is a member having sufficient strength through screwing, for example, a metal, the sensor device 18ᵢⱼ can be fixed to the target object using a screw (or a bolt). In addition, according to types and usages of target objects, the sensor device 18ᵢⱼ may be fixed to the target object using a magnetic force of a magnet instead of screwing or adhesion or in addition to screwing or adhesion.

In the following description, the sensor devices 18ᵢⱼ are also appropriately referred to as sensors 18ᵢⱼ or a sensor 18 as a generic term.

FIG. 3 illustrates an example of a structure in the middle of construction of an underground structure, specifically, parts of side walls (parts of a first wall 20 and a second wall 40 which are perpendicular to each other) of an underground space which will eventually become an underground room.

In the following description, as illustrated in FIG. 3, the vertical direction (the gravitational direction) is defined as a Y-axis direction, a direction parallel to the plane of the first wall 20 in a plane perpendicular to the Y axis is defined as an X-axis direction, a direction perpendicular to the Y axis and the X axis is defined as a Z-axis direction, and tilt (rotation) directions about the X axis, the Y axis, and the Z axis are defined as a θx direction, a θy direction, and a θz direction.

In FIG. 3, the first wall 20 is constituted by a combination of a soil-cement column-array wall 22 and a steel sheet pile wall 24, and the second wall 40 is constituted by a combination of a steel sheet pile wall 24 and a soldier-pile horizontal sheathing wall 42. In FIG. 3, each of the first wall 20 and the second wall 40 is supported by a first-stage horizontal strut timbering 50. The first-stage horizontal strut timbering 50 includes a wale member 52 arranged horizontally along the inner surfaces of the first wall 20 and the second wall 40 and a strut member (hereinafter appropriately referred to as a “strut”) 54 arranged horizontally to be perpendicular to the wale member 52. The wale member 52 is supported by a wale bearing member 55 provided in a core member of each wall along the inner surfaces of the first wall 20 and the second wall 40. As the strut 54, a plurality of struts are provided to be perpendicular to each of the first wall 20 and the second wall 40. Each strut 54 is formed substantially as one crossbeam (strut) by connecting a plurality of steel frame members arranged coaxially with an intermediate connection part interposed therebetween. The intermediate connection part is generally constituted by a joint plate, and a jack such as a hydraulic jack is provided at a partial position thereof (for example, in the vicinity of a crossing of the struts 54). Two angle braces 56 connecting both side surfaces of an end (a part close to the wall) of each strut 54 and the wale member 52 are obliquely suspended therebetween. A middle part in a longitudinal direction of each strut 54 is supported by an intermediate pile (a bearing pile) 58. In a step in which the first-stage horizontal strut timbering 50 has been constructed in this way, a preload (a pre-charge pressure in the axial direction) is applied to each strut 54 via the jack which is not illustrated. In the following description, a bearing force (an internal stress) in the axial direction of a strut is referred to as an axial force. The axial force of each strut 54 is applied as an external force directly from the strut 54 to the wale member 52 and is applied as an external force indirectly from the strut 54 to the wale member 52 via the angle braces 56. The external force applied to the wale member 52 acts on the first wall 20 or the like including the soil-cement column-array wall 22 and opposes a force applied to the soil-cement column-array wall 22 by, for example, earth or spring water on the rear side of the soil-cement column-array wall 22.

In FIG. 3, reference sign 57 denotes a strut bearing member, reference sign 59 denotes a back-filler reinforced ironwork, reference sign 61 denotes a corner angle brace, and reference sign 63 denotes a strut brace.

Although not illustrated, after the first-stage horizontal strut timbering 50 has been constructed, the earth inside of the walls is dug up to a predetermined depth and a second-stage horizontal strut timbering is constructed. This process is repeated up to a target depth in the same way.

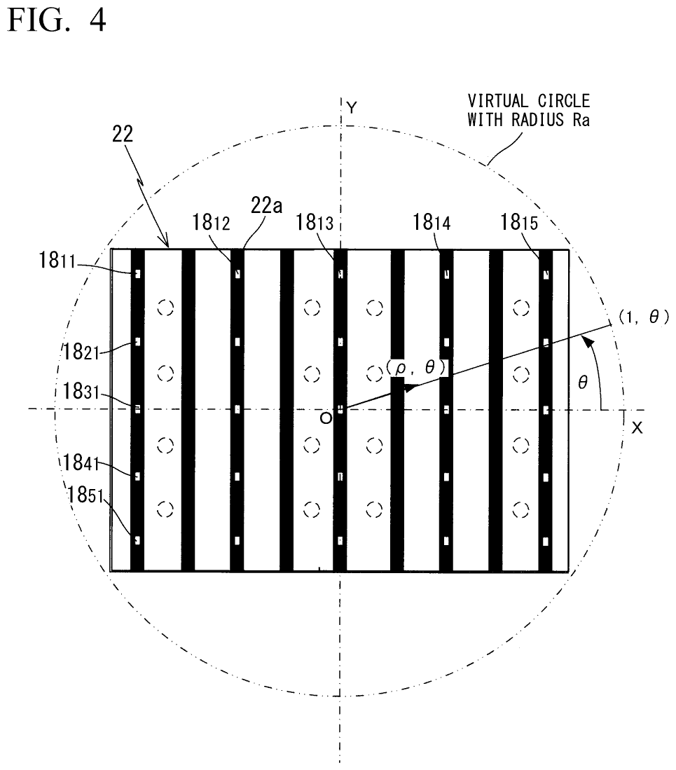

In FIG. 4, a soil-cement column-array wall 22 is partially extracted and illustrated in a simplified form after a plurality of stages of horizontal strut timbering have been constructed. In FIG. 4, a horizontal strut timbering is not illustrated. A position of the strut 54 is indicated by a dotted line.

As illustrated in FIG. 4, the sensors 18 are provided at predetermined positions of a core member 22a at certain intervals (for example, every other) on the soil-cement column-array wall 22 according to this embodiment (see FIG. 3). Here, an H-shaped steel beam is used as the core member 22a.

The plurality of sensors 18 are fixed to the same positions (these positions are pre-determined on the basis of design data by the server 12) in the longitudinal direction (the Y-axis direction) of each core member 22a in which the sensors are to be installed. That is, the plurality of sensors 18 are arranged in a matrix shape with the X-axis direction as a row direction (a direction in which a column number changes) and with the Y-axis direction as a column direction (a direction in which a row number changes). In the following description, a first row, a second row, a third row, . . . are defined sequentially from top to bottom in FIG. 4, and a first column, a second column, a third column, . . . are sequentially defined from left to right. For the purpose of identification, a sensor 18 located in an i-th row and a j-th column is referred to as a sensor device 18ᵢⱼ. In FIG. 4, reference signs are added to only some sensors located in the first row and some sensors located in the first column.

Arrangement of a plurality of sensors 18 is not limited thereto, and installation positions thereof have only to be determined in advance on the basis of design data for each core member 22a in which the sensors are to be installed. Arrangement of a plurality of sensors 18 can be two-dimensional arrangement (in other words, positions are different in at least one of the X-axis direction and the Y-axis direction), and the sensors 18 may be arranged at vertices of a figure obtained by closely arranging a plurality of regular triangles with the same size in different orientations.

The plurality of sensors 18 are fixed to target core members 22a by a worker after the ground surface inside of the soil-cement column-array wall 22 has been excavated and the surfaces of the core members 22a have been exposed. Here, each sensor 18 is fixed to a predetermined position of a corresponding core member 22a by screwing. Alternatively, a plurality of tapes with sensors in which a plurality of sensors 18 are arranged at predetermined intervals on one surface of a tape-shaped substrate and the sensors 18 are fixed to the one surface of the substrate by adhesion or the like may be prepared, and the rear surface of the substrate of the tape with sensors may be fixed to the corresponding core member 22a. A worker in charge of installation of the sensors 18 may acquire arrangement information of the sensors 18 determined by the server 12 in advance, or a manager or the like may acquire the arrangement information on the spot through transmission and reception of information via a mobile terminal 16. It is also conceivable that the plurality of sensors 18 be fixed to the core member 22a in advance in a factory before the core member 22a is buried in cement milk at the time of construction of the soil-cement column-array wall 22.

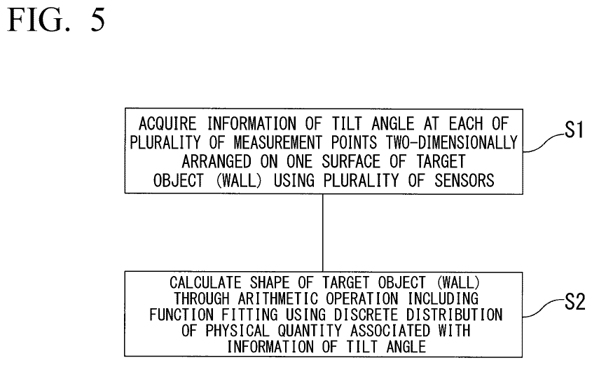

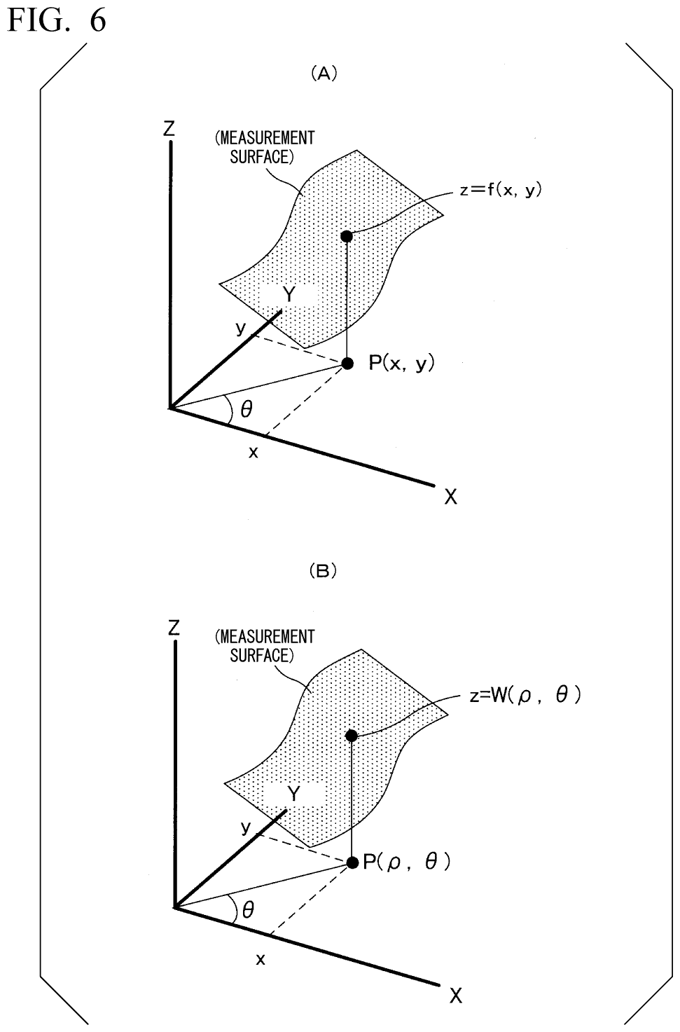

A flow of a shape acquisition method according to this embodiment will be described below with reference to the flowchart illustrated in FIG. 5.

Preconditions for starting shape acquisition will be described below before the flow of shape acquisition is described.

As preconditions, a plurality of sensors 18ᵢⱼ are arranged in a matrix shape with the X-axis direction as a row direction (a direction in which a column number changes) and with the Y-axis direction as a column direction (a direction in which a row number changes) on the soil-cement column-array wall 22 as described above. Here, it is assumed that the sensors 18ᵢⱼ are calibrated in advance (before installation) such that a measurement error is not caused.

A field worker turns on the switch 186 of each sensor 18ᵢⱼ such that communication via the network 13 is possible and then performs necessary initial setting in advance. The initial setting of the sensor 18ᵢⱼ includes inputting identification information of the sensor 18ᵢⱼ via the display and operation unit 187. Specifically, identification information (01-ij) is individually input to the sensor 18ᵢⱼ in the i-th row and the j-th column, and the arithmetic processing unit 182 thereof stores the input identification information in an internal memory (a RAM). Here, “01” in the identification information is an identification code of the first wall 20 including the soil-cement column-array wall 22 which is a measurement target, and “ij” is an identification code of the corresponding sensor 18ᵢⱼ. For example, identification information (01-11), (01-12), and (01-13) is individually input to three sensors 1811, 1812, and 1813 in the first row illustrated in FIG. 4. The identification code ij indicates an installation position of the corresponding sensor 18ᵢⱼ, and the installation position is recognized by the server 12. It is assumed that no sensor 18 is installed on the steel sheet pile wall 24 of the first wall 20. In the following description, the soil-cement column-array wall 22 and the first wall 20 are appropriately indiscriminately used, and the soil-cement column-array wall 22 is appropriately referred to as a “target object (wall) 22.” When the initial setting is completed, each sensor 18ᵢⱼ falls into a standby state in which measurement can be performed at any time. After the initial setting has been performed, the switch 186 of each sensor 18j is maintained in an ON state. In a configuration in which the power supply of each sensor 18 can be turned on and off through external operation, the power supply may be temporarily set to an OFF state after the initial setting has been performed. When the plurality of sensors 18 are fixed to the core member in advance in a factory, it is preferable that the power supply of each sensor 18 be turned on and off through external operation.

On the basis of the preconditions, information of a tilt angle at each of a plurality of measurement points two-dimensionally arranged on one surface of the target object (wall) 22 is acquired using the sensors 18ᵢⱼ (Step S1 in FIG. 5).

Subsequently, when acquisition of the information of the tilt angle at each measurement point on the target object (wall) 22 ends, a shape of the target object (wall) 22 is calculated through an arithmetic operation including function fitting using a discrete distribution of a physical quantity associated with the acquired information of the tilt angles (Step S2 in FIG. 5). The process of Step S2 will be described below in detail.

In this embodiment, it is assumed that a shape of the one surface in which the sensors 18 are installed (hereinafter also referred to as a measurement surface) is calculated as the shape of the target object (wall) 22. The shape of the measurement surface can also be referred to as a deformation distribution of the target object.

As illustrated in FIG. 6(A), the measurement surface corresponds to a set of points of Z positions z at points P (x, y) on the XY plane in a three-dimensional orthogonal coordinate system (x, y, z) and can be represented by a function z=f(x, y). On the other hand, as illustrated in FIG. 6(B), a point P is expressed by P(ρ, θ) in a polar coordinate system (x=ρ cos θ, y=ρ sin θ). Accordingly, the measurement surface W can be represented by z=W(ρ, θ) in the polar coordinate system (x=ρ cos θ, y=ρ sin θ). In the following description, the measurement surface is appropriately referred to as a measurement surface W or a measurement surface W(ρ, θ).

Tilt angles α, β, and γ in three directions (a θx direction, a θy direction, and a θz direction) at the installation positions of the sensors 18 are acquired as outputs of the sensors 18 and are the same as tilt angles of normal vectors of the measurement surface W at the measurement points of the sensors 18. In the following description, the θz direction will not be considered.

The shape of the measurement surface (a surface shape) of a target object can be derived from the measurement point coordinates and the measured values of the tilt angle of the normal vector. For example, an amount of separation z of each measurement point from the reference plane (the XY plane) (that is, a height z from the reference plane which is also appropriately referred to as a height z) is calculated using a gradient of a surface slope at each measurement point (coordinates (x, y)) and a first-order integral thereof, geometric calculation, or the like. Accordingly, information of a discrete in-plane distribution of the amount of separation z from the reference plane at a plurality of measurement points is acquired. However, in this step, information of a height z of a point other than the points at which the sensors 18 are installed cannot only be approximately calculated using proportional calculation or the like, and it is difficult to accurately calculate the information. For example, when no sensor 18 is installed at a position with a maximum height z, it is also difficult to calculate a maximum value of the height z.

Therefore, in this embodiment, a function representing the measurement surface W is acquired by fitting the discrete information to a function. A function of an arbitrary orthogonal polynomial can be used for the fitting to a function. It is possible to uniquely define an amount of deformation and a position at which the deformation occurs using the orthogonal polynomial.

In this embodiment, a Zernike polynomial is used as the orthogonal polynomial. The Zernike polynomial is an orthogonal polynomial which is defined on a unit circle.

A first method using a Zernike polynomial will be described below.

### <<First Method>

A Zernike polynomial is defined by the following expression.

$$\begin{matrix}[ Math . 1 ] & \\ {Z}_{n}^{m} ( ρ , θ ) = \{ \begin{matrix}{R}_{n}^{m} ( ρ ) cos ( m θ ) & m \geq 0 \\ {R}_{n}^{\vert m \vert} ( ρ ) sin ( \vert m \vert θ ) & m < 0\end{matrix} & ( 1 )\end{matrix}$$

In Expression (1), n is a nonnegative integer, m is an integer satisfying n≥|m|, ρ is a moving radius (0≤ρ≤1), and θ is a deflection angle.

The Zernike polynomial takes a range of |Zₙ^{m}(ρ, θ)|≤1. Here, a moving radius polynomial Rₙ^{m}(ρ) is established when n-m is an even number.

$$\begin{matrix}[ Math . 2 ] & \\ {R}_{n}^{m} ( ρ ) = {{\sum }^{\frac{n - m}{2}}}_{s = 0} \frac{{( - 1 )}^{s} ( n - s ) !}{s ! ( \frac{n + m}{2} - s ) ! ( \frac{n - m}{2} - s ) !} {ρ}^{n - 2 s} & ( 2 )\end{matrix}$$

Here, when n-m is an odd number, the moving radius polynomial is defined as 0.

Here, two indices n and m are integrated into a single index i using the Fringe indexing scheme.

That is, in the Fringe-Zernike polynomial, the index i is defined as follows.

$$\begin{matrix}[ Math . 3 ] & \\ i = {( 1 + \frac{n + \vert m \vert}{2} )}^{2} - 2 \vert m \vert + \frac{1 - sgn m}{2} & ( 3 )\end{matrix}$$

A relationship between the indices n and m and the index i of the first several terms in the Fringe-Zernike polynomial calculated by Expression (3) is described in Table 1.

TABLE 1

| | | | | | | | | | | | | | | | | | | | | |
|---|---|---|---|---|---|---|---|---|---|---|---|---|---|---|---|---|---|---|---|---|
| n | 0 | 1 | 1, | 2 | 2 | 2 | 3 | 3 | 4 | 3 | 3 | 4 | 4 | 5 | 5 | 6 | 4 | 4 | 5 | 5 |
| m | 0 | 1 | −1 | 0 | 2 | −2 | 1 | −1 | 0 | 3 | −3 | 2 | −2 | 1 | −1 | 0 | 4 | −4 | 3 | −3 |
| i | 1 | 2 | 3 | 4 | 5 | 6 | 7 | 8 | 9 | 10 | 11 | 12 | 13 | 14 | 15 | 16 | 17 | 18 | 19 | 20 |

In this embodiment, appropriately, the terms in the Fringe-Zernike polynomial are referred to as Zᵢ(ρ, θ). Accordingly, a measurement surface W(ρ, θ) can be expressed by the following expression.

$$\begin{matrix}[ Math . 4 ] & \\ W ( ρ , θ ) = {\sum }_{i} {k}_{i} \cdot {Z}_{i} ( ρ , θ ) & ( 4 )\end{matrix}$$

Here, kᵢ is a coefficient of each term Z(ρ, θ).

Zᵢ(ρ, θ) up to the 37-th term along with the coefficient kᵢ is described in Table 2.

TABLE 2

| kᵢ | Zᵢ |
|---|---|
| k₁ | 1 |
| k₂ | ρcosθ |
| k₃ | ρsinθ |
| k₄ | 2ρ² − 1 |
| k₅ | ρ²cos2θ |
| k₆ | ρ²sin2θ |
| k₇ | (3ρ³ − 2ρ) cosθ |
| k₈ | (3ρ³ − 2ρ) sinθ |
| k₉ | 6ρ⁴ − 6ρ² + 1 |
| k₁₀ | ρ³cos3θ |
| k₁₁ | ρ³sin3θ |
| k₁₂ | (4ρ⁴ − 3ρ²) cos2θ |
| k₁₃ | (4ρ⁴ − 3ρ²) sin2θ |
| k₁₄ | (10ρ⁵ − 12ρ³ + 3ρ) cosθ |
| k₁₅ | (10ρ⁵ − 12ρ³ + 3ρ) sinθ |
| k₁₆ | 20ρ⁶ − 30ρ⁴ + 12ρ² − 1 |
| k₁₇ | ρ⁴cos4θ |
| k₁₈ | ρ⁴sin4θ |
| k₁₉ | (5ρ⁵ − 4ρ³) cos3θ |
| k₂₀ | (5ρ⁵ − 4ρ³) sin3θ |
| k₂₁ | (15ρ⁶ − 20ρ⁴ + 6ρ²) cos2θ |
| k₂₂ | (15ρ⁶ − 20ρ⁴ + 6ρ²) sin2θ |
| k₂₃ | (35ρ⁷ − 60ρ⁵ + 30ρ³ − 4ρ) cosθ |
| k₂₄ | (35ρ⁷ − 60ρ⁵ + 30ρ³ − 4ρ) sinθ |
| k₂₅ | 70ρ⁸ − 140ρ⁶ + 90ρ⁴ − 20ρ² + 1 |
| k₂₆ | ρ⁵cos5θ |
| k₂₇ | ρ⁵sin5θ |
| k₂₈ | (6ρ⁶ − 5ρ⁴) cos4θ |
| k₂₉ | (6ρ⁶ − 5ρ⁴) sin4θ |
| k₃₀ | (21ρ⁷ − 30ρ⁵ + 10ρ³) cos3θ |
| k₃₁ | (21ρ⁷ − 30ρ⁵ + 10ρ³) sin3θ |
| k₃₂ | (56ρ⁸ − 105ρ⁶ + 60ρ⁴ − 10ρ²) cos2θ |
| k₃₃ | (56ρ⁸ − 105ρ⁶ + 60ρ⁴ − 10ρ²) sin2θ |
| k₃₄ | (126ρ⁹ − 280ρ⁷ + 210ρ⁵ − 60ρ³ + 5ρ) cosθ |
| k₃₅ | (126ρ⁹ − 280ρ⁷ + 210ρ⁵ − 60ρ³ + 5ρ) sinθ |
| k₃₆ | 252ρ¹⁰ − 630ρ⁸ + 560ρ⁶ − 210ρ⁴ + 30ρ² − 1 |
| k₃₇ | 924ρ¹² − 2772ρ¹⁰ + 3150ρ⁸ − 1680ρ⁶ + 420ρ⁴ − 42ρ² + 1 |

Here, since Expression (4) is calculated by the number of sensors 18 (the number of measurement points), the second to q-th terms (for example, to the 37-th term) in the Zernike polynomial are used for fitting, the number of sensors 18 is defined as K (K>q−1), and z acquired at each measurement point of the K sensors 18 is fitted to the function. That is, the coefficients kᵢ (i=2, 3, . . . q) of the terms in Expression (4) are calculated by solving K observation equations. Here, since z includes an error, the coefficients are calculated using a least square method in order to minimize the error included in the coefficients kᵢ.

In the first method, through the aforementioned technique, the coefficients kᵢ of the terms in the function W(ρ, θ) are calculated, and the function W(ρ, θ) after the coefficients kᵢ has been defined is calculated as a shape of a surface of a target object, that is, a function of a deformation distribution. With the first method, information of the height z of a point other than the points at which the sensors 18 are installed can also be calculated by the function z=W(ρ, θ) without performing proportional calculation, and a most protruded position and an amount of protrusion thereof can be calculated by the function z=W(ρ, θ), for example, even when no sensor 18 is installed at the most protruded position.

### <<Second Method>>

Tilt angles α and β in the θx and θy directions of the normal vector of the measurement surface at the measurement points which are outputs of the sensors 18 are the same as a gradient of a tangent plane to the measurement surface expressed by the function z=W(ρ, θ) at the measurement points and can be expressed by gradients α=∂W/∂X and β=∂W/∂y. Here, α=∂W/∂x and β=∂W/∂y are derivatives of the function W.

Accordingly, by fitting the measured values of the discrete sensors 18 to a function obtained by differentiating the Zernike polynomial (also referred to as a differential Zernike polynomial in this specification), a function dW(ρ, θ) representing a distribution of the measured values of the sensors 18 can be acquired instead of using the first method. The function W(ρ, θ) can be acquired by integrating the acquired function dW(ρ, θ).

A second method using the differential Zernike polynomial will be described below in brief.

The distribution dW(ρ, θ) of the measured values can be expressed by Expression (5) using the differential Zernike polynomial.

$$\begin{matrix}[ Math . 5 ] & \\ dW ( ρ , θ ) = {\sum }_{i} {k}_{i} \cdot {Z}_{i}^{′} ( ρ , θ ) & ( 5 )\end{matrix}$$

Actually, tilt angles α=∂W/∂x and β=∂W/∂y are acquired for each sensor 18.

The x partial differential ∂Z/∂X in Expression (1) is expressed as follows.

$$\begin{matrix}[ Math . 6 ] & \\ \begin{matrix}\frac{\partial Z}{\partial x} = \frac{\partial }{\partial x} ( {R}_{n}^{m} ( ρ ) cos ( m θ ) ) & ( m \geq 0 )\end{matrix} \begin{matrix}\frac{\partial Z}{\partial x} = \frac{\partial }{\partial x} ( {R}_{n}^{m} ( ρ ) sin ( \vert m \vert θ ) ) & ( m < 0 )\end{matrix} & ( 6 )\end{matrix}$$

The y partial differential ∂Z/∂y in Expression (1) is expressed as follows.

$$\begin{matrix}[ Math . 7 ] & \\ \begin{matrix}\frac{\partial Z}{\partial y} = \frac{\partial }{\partial y} ( {R}_{n}^{m} ( ρ ) cos ( m θ ) ) & ( m \geq 0 )\end{matrix} \begin{matrix}\frac{\partial Z}{\partial y} = \frac{\partial }{\partial y} ( {R}_{n}^{m} ( ρ ) sin ( \vert m \vert θ ) ) & ( m < 0 )\end{matrix} & ( 7 )\end{matrix}$$

The differentials ∂/∂x and ∂/∂y in the polar coordinate system are expressed by Expression (8). In Expression (6) and Expression (7), cos (mθ)=1 is obtained at m=0.

$$\begin{matrix}[ Math . 8 ] & \\ \frac{\partial }{\partial x} = cos θ \frac{\partial }{\partial ρ} - \frac{1}{ρ} sin θ \frac{\partial }{\partial θ} \frac{\partial }{\partial y} = sin θ \frac{\partial }{\partial ρ} + \frac{1}{ρ} cos θ \frac{\partial }{\partial θ} & ( 8 )\end{matrix}$$

A general system of an nth-degree mθ term of partial differentials of Z ∂Z/∂x and ∂Z/∂y is calculated through calculation of applying Expression (8) to Expression (6) and Expression (7), the indices m and n of the calculated terms are integrated into a single index i using Expression (3), and the terms of the differential Zernike polynomial Z′(ρ, θ) obtained by differentiating the Fringe-Zernike polynomial can be calculated by arranging the terms according to the order of the integrated indices.

In this embodiment, the Zernike polynomial, the differential Zernike polynomial, and expressions of the terms thereof are calculated in advance and are stored in the storage of the server 12.

The measured values (∂W/x and ∂W/y) of the discrete sensors 18 are fitted to the polynomial of Expression (5) and the coefficients kᵢ of the terms thereof are calculated using a least square method. At this time, when the number of sensors 18 is defined as K, the number of observation equations is 2K. Accordingly, the coefficients kᵢ of the terms in the polynomial of Expression (5) can be calculated. In the second method, since calculation (approximate calculation) for calculating the height z from the measured values of the sensors 18 is not performed, the values of the calculated coefficients kᵢ have a smaller error with respect to a true value than that in the first method.

The calculated coefficients of the terms are set as definitive coefficients kᵢ of the corresponding terms in Expression (5), and the function W(ρ, θ) is calculated by integrating the polynomial of Expression (5) of which the coefficients have been defined.

$$\begin{matrix}[ Math . 9 ] & \\ \int d W ( ρ , θ ) = W ( p , θ ) = {\sum }_{i} {k}_{i} \cdot {Z}_{i} ( ρ , θ ) & ( 9 )\end{matrix}$$

The function of Expression (9) obtained as the result of integration matches the function W(ρ, θ) obtained by substituting the definitive coefficients kᵢ of the terms in this case into Expression (4).

With the second method, similarly to the first method, information of the height z of a point other than the points at which the sensors 18 are installed can also be calculated by the function z=W(ρ, θ) without performing proportional calculation, and a most protruded position and an amount of protrusion thereof can be calculated by the function z=W(ρ, θ), for example, even when no sensor 18 is installed at the most protruded position. In addition, in comparison with the first method, since the error with respect to the true values of kᵢ is smaller, it is possible to more accurately calculate a shape of a surface represented by W(ρ, θ).

Since Steps S1 and S2 are performed by the shape acquisition system 10 in this embodiment, operations of the constituents of the shape acquisition system 10 will be described below.

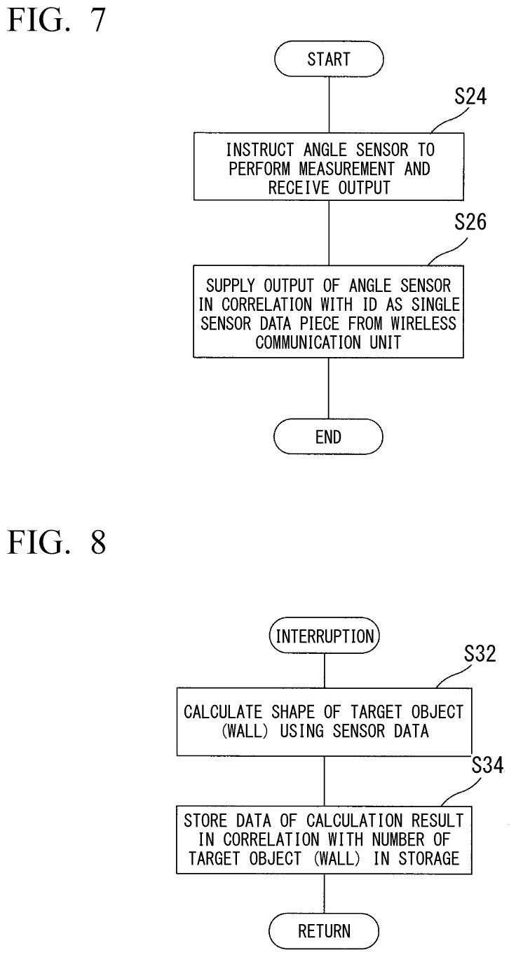

First, the operation of each sensor 18 used in the process of Step S1 will be described with reference to the flowchart illustrated in FIG. 7. This flowchart represents a process algorithm which is defined by programs executed by the CPU of the arithmetic processing unit 182. It is assumed that the process algorithm illustrated in the flowchart of FIG. 7 is started when an instruction for measurement start is input.

First, in Step S24, the angle sensor 181 is instructed for measurement, and information of the tilt angle (at least two directions including the θx direction and the θy direction herein) measured by the angle sensor 181 are received.

Then, in Step S26, an ID (an identification code) is allocated to the received output information, and the resultant information is transmitted as a piece of sensor data to the server 12 via the communication unit 183 and the network 13. Here, as the ID, a number (a code) which is prepared on the basis of identification information input by a worker at the time of initial setting and stored in the RAM is used.

When the process of Step S26 is completed, the process flow ends. Accordingly, the sensor 18ᵢⱼ becomes a standby state until a next instruction for measurement start is input.

The processes of Steps S24 and S26 are performed by all the sensors 18ᵢⱼ.

The server 12 sequentially stores the transmitted sensor data in a predetermined storage area of the RAM. When a plurality of pieces of sensor data are simultaneously transmitted, the server 12 simultaneously stores the sensor data in the predetermined storage area of the RAM in parallel through a time division process.

Then, the operation of the server 12 used in the process of Step S2 will be described with reference to the flowchart illustrated in FIG. 8. This flowchart represents a process algorithm of an interruption routine which is defined by programs executed by the CPU of the server 12.

The interruption routine is performed whenever reading of sensor data from all the sensors 18 installed on the target object (wall) 22 ends.

First, in Step S32, a surface shape (a deformation distribution) W represented by the polynomial of Expression (4) or (9) is calculated as shape information of a wall which is a target object using the first method or the second method based on the received sensor data.

Then, in Step S34, the calculated shape data is stored in the storage (such as the HDD) in correlation with the number of the target object, and then the process flow exits the interruption routine (returns to the main routine). Here, the shape data is stored as data of the following matrix Q in correlation with ID data of the target object (wall).

$$\begin{matrix}[ Math . 10 ] & \\ Q = [ \begin{matrix}{k}_{2} \\ {k}_{3} \\ ⋮ \\ ⋮ \\ {k}_{q}\end{matrix} ] & ( 10 )\end{matrix}$$

When the polynomial W includes the second to 37-th terms, q=37 is obtained.

The interruption routine illustrated in FIG. 8 is performed whenever sensor data of a wall (a target object) is read. That is, calculating a shape and storing a calculation result in correlation with a wall number (a number of a target object) are repeatedly performed whenever sensor data is read for each wall (target object) to be measured.

Therefore, a rewritable data table in which numbers of target object (wall numbers) are correlated with predetermined areas of the storage may be prepared in advance, and the areas correlated with the numbers of target objects (wall numbers) may be repeatedly overwritten (that is, stored content may be updated) when the calculation results are stored.

In this embodiment, the server 12 includes a database including the data table in which newest information stored in the storage is correlated with design data and updates the database whenever measurement ends. In general, the design data itself is stored in a predetermined area of the data table and is not updated.

In this case, change with time of a shape of a target object (wall) can also be monitored on the basis of the prepared and updated database.

In this embodiment, at a time point before first measurement of a target object (wall) is started, dummy data is stored in an area in the database in which data of measurement results is stored. At a time at which the first measurement has ended, the database is updated at the first time.

According to necessity, the server 12 may transmit information including the measurement results to the field-side computer 14 via the network 13 when update of the database is performed.

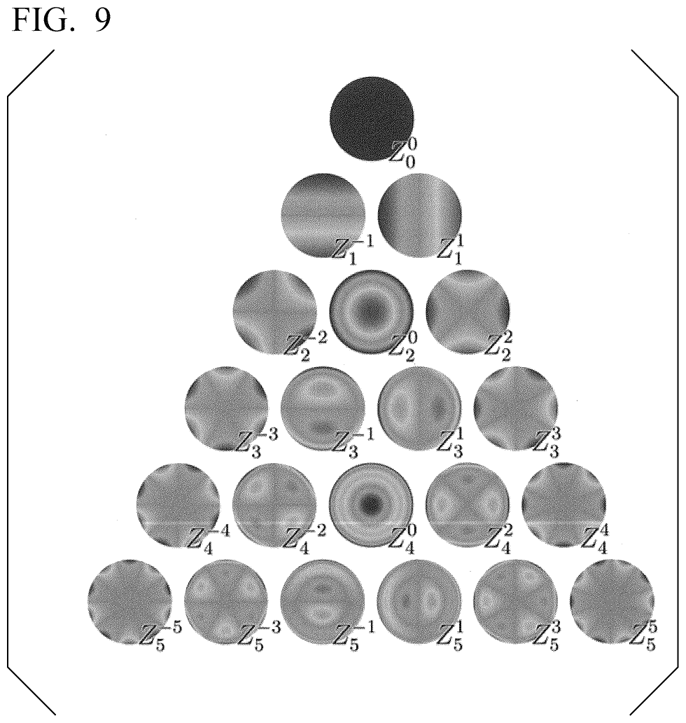

Component decomposition of a Zernike polynomial will be described below. For the purpose of easy understanding, components of the first several terms in the Zernike polynomial of Expression (1) are illustrated in a shaded pattern in unit circles in the polar coordinate system (ρ, θ) (the concentration at each coordinate point (ρ, θ) corresponds to the magnitude (which can also be referred to as a degree of deformation) at a z position at that point) in FIG. 9. FIG. 9 illustrates a part of a map which also called a Zernike mode map.

What degrees the components of the terms are included can be seen from the values of the definitive coefficients kᵢ of the terms in Expression (4) or Expression (9), and degrees of deformation of the constituents parts in the circles can be additionally seen from the component diagrams of FIG. 9. For example, when k₄, k₉, and k₁₆ are larger than the other coefficients, it can be seen that the components Z₄, Z₉, and Z₁₆ including them as coefficients are more included than the other components. Since 4, 9, and 16 of the Fringe-Zernike order are obtained by arranging two indices (2, 0), (4, 0), and (6, 0) and integrating the indices into one index, it can be seen from the image of FIG. 9 that the central part in the circles most protrudes. Z₁₆ is not illustrated in FIG. 9. In this embodiment, for example, Zernike mode maps of the first to 91-th terms in the Zernike polynomial are stored in the storage of the server 12. Accordingly, the server 12 can numerically calculate, for example, the most protruded position (ρ, θ) and an amount of deformation (an amount of separation from the reference plane) thereof on the basis of the values of the coefficients kᵢ of the terms and the Zernike mode maps by decomposing the Zernike polynomial representing a shape of a one surface of the target object, that is, an in-plane distribution of an amount of deformation.

In actual measurement using an earth retaining wall as a target object, as illustrated in FIG. 4, the XY coordinate system with the center of a rectangular earth retaining wall as an origin O is converted to the polar coordinate system (ρ, θ), a virtual unit circle (0≤ρ≤1) circumscribing vertices of four corners of the earth retaining wall is set in the polar coordinate system. The unit circle corresponds to a virtual circle with a radius Ra centered on the origin O in the XY coordinate system. In other words, a unit circle in the polar coordinate system is a circle obtained by reducing a circle with a radius Ra in the XY coordinate system having the same origin at a reduction rate 1/Ra. In the polar coordinate system, an angle from an axis corresponding to the X axis is a deflection angle θ.

When an actual position of a measurement point at which a sensor 18 is installed is (a, b), the calculated coordinate position of the measurement point is (a/Ra, b/Ra), and various types of calculation such as function fitting are performed on the basis thereof.

### <<Measurement of Deformation of Earth Retaining Wall Due to Ground Water>>

When deformation of an earth retaining wall due to ground water or the like is calculated using the sensors 18, a flatness of a wall is set to a reference level by applying axial forces to specific struts 54 (which may include all of a plurality of struts 54) which are selected using a predetermined criterion on the basis of design data out of the plurality of struts 54 at a certain time point and adjusting the axial forces. The reference level means a state in which unevenness of the whole wall is equal to or less than a predetermined threshold value. At this time, adjustment of the axial force for each strut 54 is visually performed, for example, by an expert.

At a time point at which it is determined that the flatness of the wall enters the reference level, the series of measuring processes of Steps S1 and S2 is performed. This series of measuring processes is started on the basis of an instruction from a field-side manager or the like to a manager of the server 12. Then, the server 12 evaluates the flatness on the basis of the results of component decomposition of the terms of the acquired shape information of the wall (the polynomial W). When the flatness enters the reference level, flatness OK information is transmitted. ON the other hand, when the flatness does not enter the reference level, information of a position at which the flatness does not enter the reference level, an amount of deformation at the position, and the like is calculated by the server 12, and the information is transmitted.

The field-side manager or the like ascertains that the wall is set to the reference level on the basis of the transmitted flatness OK information. On the other hand, when the information of a position at which the flatness does not enter the reference level and an amount of deformation at the position is received, the field-side manager or the like notifies a field worker of that result. Accordingly, necessary adjustment of the axial forces of the struts 54 is performed by the field worker. When this adjustment ends, the aforementioned measuring processes are performed again by the shape acquisition system 10.

Then, when it is ascertained through measurement that the flatness enters the reference level, the server 12 notifies of the flatness OK information and updates the database. In the following description, a time point at which the flatness OK information is notified of and the data base is updated is referred to as a first time point, and data stored in the database at that time point is referred to as reference-time data.

When deformation of the earth retaining wall due to ground water or the like is calculated using the sensors 18 at a second time point at which a predetermined time elapses from the first time point, an instruction for measurement is transmitted from the field-side manager or the like to the manager of the server 12, and the aforementioned series of measuring processes is performed in accordance with the instruction. Then, the server 12 evaluates a deformation state of the target object (wall) from the results of component decomposition of the terms of the calculated shape information of the wall (the aforementioned polynomial W). Specifically, an amount of change Δkᵢ of the coefficient kᵢ for each term is calculated from the values of the coefficient kᵢ of each term included in the reference-time data and the values of the coefficients kᵢ of the corresponding terms included in measurement data at the second time point stored in the RAM, and a position (ρ, θ) with great deformation of the wall can be numerically identified on the basis of the values of the amount of change Δkᵢ and the aforementioned Zernike mode maps. For example, when the amount of change of the coefficient of the term 0θ such as Δk₄, Δk₉, and Δk₁₆ is large, it can be seen that particularly great deformation is generated in a central part of the target object (wall). In this case, an excavation position on the rear side of the earth retaining wall can be determined on the basis of the position at which the great deformation is generated, and measures of draining the ground on the rear side of the wall at that position or the like can be taken.

<<Optimal Support of Target Object (Wall) with Strut>>

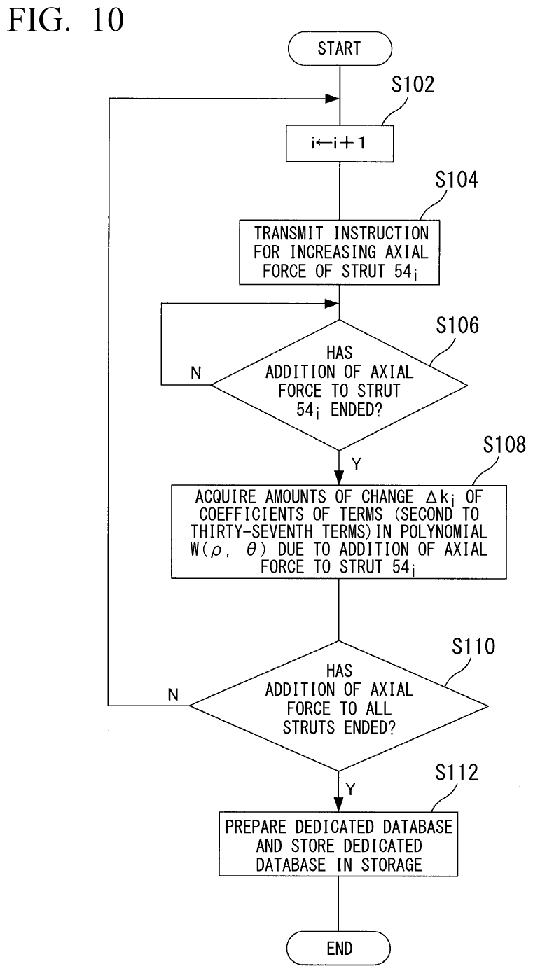

When optimal support with the struts 54 is realized, it is necessary to prepare a dedicated database in advance. Preparation of the dedicated database will be described below with reference to the flowchart of FIG. 10 illustrating a process algorithm which is performed by the server 12.

As preconditions, the flatness of a target object (wall) is set to the reference level in the same sequence as described above and in a state in which axial forces are applied to all of a plurality of (N herein) struts 54. A series of measuring processes is performed on the wall in the state in which the flatness is set to the reference level, component decomposition of the shape information of the wall (the polynomial W) calculated through the measurement, and data of the coefficients kᵢ of the terms or the like is stored in a predetermined storage area of the RAM in correlation with identification data of the struts 54 and data of the axial forces. It is assumed that a counter i which will be described later is initialized to 0. Under these preconditions, preparation of the dedicated database is performed as follows.

First, in Step S102, the counter i indicating the number of a strut 54 is increased by 1 (i←i+1). Accordingly, the counter i is set to 1.

Then, in Step S104, the server 12 transmits an instruction for increasing an axial force for the i-th (first, herein) strut 54ᵢ to the field-side computer 14. Accordingly, the instruction for increasing an axial force for the i-th (first, herein) strut 54ᵢ is given from the field-side manager to a worker, a jack is operated by the worker to additionally apply an axial force with a predetermined magnitude to the instructed strut 54ᵢ. Here, the axial force with a predetermined magnitude may be defined as an axial force with a predetermined size (a bearing force with a predetermined magnitude or a bearing force with a unit magnitude) to such an extent that measurable deformation (as a result of measurement, an amount of change (with respect to the reference data) Δkᵢ of at least one term out of the coefficients of the terms of from the second to q-th terms (for example, to the 37-th term) in the polynomial W is not zero) can be caused in the target object.

Then, in Step S106, end of the application of an axial force to the strut 54ᵢ is waited for. Then, when the work of applying the axial force to the i-th strut (first, herein) strut 54ᵢ ends, the manager is notified thereof, and information indicating that the work of applying the axial force with the predetermined magnitude to the i-th strut (first, herein) strut 54ᵢ ends from the field-side manager to the server 12 is transmitted. When this information is received by the server 12, the determination result of Step S106 is positive, and the process flow proceeds to Step S108.

In Step S108, the process of acquiring the amounts of change Δkᵢ of the coefficients of the terms (the second to q-th terms) in the polynomial W(ρ, θ) due to the application of the axial force with the predetermined magnitude to the i-th (first, herein) strut 54ᵢ is performed. The process of Step S108 is performed by performing the series of measuring processes of Steps S1 and S2, additionally performing component decomposition of the shape information of the wall (the aforementioned polynomial W), and storing the amounts of change Δkᵢ of the coefficients of the terms (the second to q-th terms) in the polynomial W(ρ, θ) due to the additional application of the axial force with the predetermined magnitude to the i-th strut 54ᵢ in a predetermined area in the RAM in correlation with identification data of the i-th strut 54ᵢ.

Then, in Step S110, it is determined whether the work of applying an axial force to all the struts 54 has ended. Here, since application of an axial force to the first strut 54₁ has only to end, the determination result of Step S110 is negative, the process flow returns to Step S102, and the processes of Steps S102 to S110 (which includes the determination) are repeatedly performed until the determination result of Step S110 is positive. Accordingly, application of an axial force to the second strut 54 and the struts subsequent thereto (Step S104) and acquisition of the amounts of change of the coefficients after the axial force has been added (Step S108) are performed in the same way as described above. At the time of addition of an axial force to the second strut 54 and the struts subsequent thereto, addition of an axial force is performed after the axial force for the (i−1)-th strut 54 has been returned to the axial force immediately before the axial force with the predetermined magnitude is applied.

Then, when addition of an axial force to the N-th strut 54N (Step S104) and acquisition of the amounts of change of the coefficients after the axial force has been added (Step S108) end and the determination result of Step S110 is positive, the dedicated database is prepared and stored in the storage in Step S112. The process of Step S112 is realized as follows. That is, a matrix O represented by the following expression is prepared using first to N-th pieces of data stored in the area of the RAM up to that time point. Data of the matrix O is stored as the dedicated database in the storage.

$$\begin{matrix}[ Math . 11 ] & \\ O = [ \begin{matrix}Δ {k}_{21} & Δ {k}_{22} & … & … & Δ {k}_{2 N} \\ Δ {k}_{31} & Δ {k}_{32} & … & … & Δ {k}_{3 N} \\ ⋮ & & & & ⋮ \\ ⋮ & & & & ⋮ \\ Δ {k}_{q 1} & Δ {k}_{q 2} & & & Δ {k}_{qN}\end{matrix} ] & ( 11 )\end{matrix}$$

Here, the first subscript of k represents a term number in the Zernike polynomial, and the second subscript thereof represents a number of the strut 54 on which data is acquired at the time of addition of an axial force thereto. When the polynomial W includes the second to 37-th terms, q=37 is established. Accordingly, the matrix O is a matrix of 36 rows and N columns.

When the process of Step S112 ends, the process flow ends.

Although not realistic, it is also conceivable that the process of preparing the dedicated database be performed by simulation.

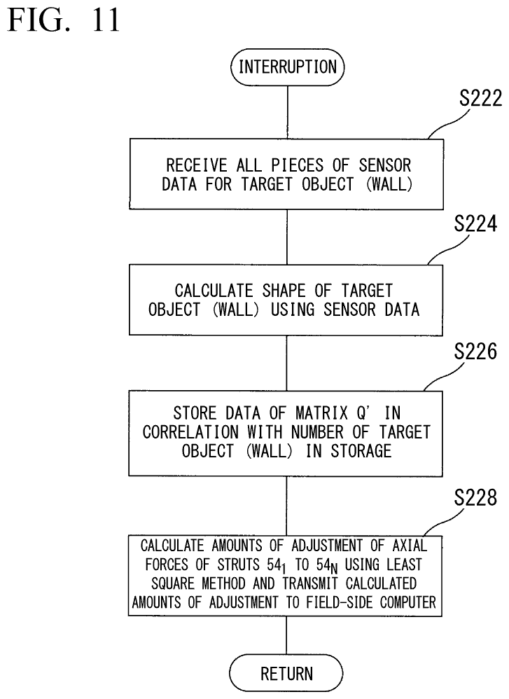

When optimal adjustment of axial forces for the struts supporting the target object (wall) 22 is performed after the dedicated database has been prepared, an optimal adjustment value is calculated by causing the server 12 to perform an interruption routine illustrated in FIG. 11 and is transmitted to the field-side computer 14.

The interruption routine illustrated in FIG. 11 is performed at a timing at which starting conditions of the interruption routine have been satisfied. The starting conditions include a condition in which an instruction for calculating an optimal adjustment value of the axial force of a strut is transmitted from the field-side computer 14 to the server 12 or a condition in which it is time to perform automatic setting for instructing to calculate the optimal adjustment value when the setting is performed at predetermined intervals.

When the starting conditions of the interruption routine are satisfied, all pieces of sensor data for the target object (wall) 22 are acquired in the same way as described above in Step S222.

Then, in Step S224, a shape of a surface (a deformation distribution) W represented by the polynomial of Expression (4) or Expression (9) is calculated as shape information of the wall which is a target object using the first method or the second method based on the received sensor data.

Then, in Step S226, amounts of change Δkᵢ (i=2, 3, . . . q) from a reference time point of the coefficients of the second to q-th terms in the polynomial W are calculated on the basis of the calculated shape data and the reference-time data, and data of a column matrix (that is, a vertical vector) Q′ expressed by Expression (12) having the calculated amounts of change Δkᵢ (i=2, 3, . . . q) as elements is stored in the storage (such as an HDD) in correlation with the number of the target object (wall).

$$\begin{matrix}[ Math . 12 ] & \\ {Q}^{′} = [ \begin{matrix}Δ {k}_{2} \\ Δ {k}_{3} \\ ⋮ \\ ⋮ \\ Δ {k}_{q}\end{matrix} ] & ( 12 )\end{matrix}$$

A relationship represented by Expression (13) is established among the column matrix Q′, the matrix O stored as the database in the hard disk, and the adjustment values P of the axial forces for a plurality of struts 54.

$${Q}^{′} = O \cdot P \qquad ( 13 )$$

In Expression (13), P is a column matrix (that is, a vertical vector) having N elements represented by Expression (14).

$$\begin{matrix}[ Math . 13 ] & \\ P = [ \begin{matrix}{ADJ}_{1} \\ {ADJ}_{2} \\ ⋮ \\ ⋮ \\ {ADJ}_{N}\end{matrix} ] & ( 14 )\end{matrix}$$

Then, in Step S228, the elements ADJ₁ to ADJ_{N}, that is, the adjustment values (target adjustment values) of the axial forces for the struts 54₁ to 54_{N}, are calculated using a least square method by performing calculation of Expression (14), data of the target adjustment values is transmitted to the field-side computer 14, and then the process flow returns to the main routine (the process flow exits the interruption routine).

$$P = {( {O}^{T} \cdot O )}^{- 1} \cdot {O}^{T} \cdot {Q}^{′} \qquad ( 15 )$$

In Expression (15), O^{T} is a transposed matrix of the matrix O, and (O^{T}·O)⁻¹ is an inverse matrix of (O^{T}·O).

The field-side manager having received the data of the target adjustment values notifies a worker of an instruction for readjustment of the axial forces for the struts 54 and the received data of the target adjustment values. The worker adjusts the axial forces for the struts 54 according to the data of the target adjustment values in response to the instruction for readjustment of the axial forces for the struts 54. Accordingly, the flatness of the target object (wall) is set to the reference level.

Since the dedicated database represented by Expression (11) is prepared in advance and stored in the storage of the server 12, the server 12 performs the interruption routine at predetermined intervals when the interruption routine is automatically set. Accordingly, when the axial forces for the struts 54₁ to 54_{N} are adjusted according to the target adjustment values in the field whenever data of a target adjustment value is received, it is possible to simulatively realize automated control of deformation of a target object (wall).

When monitoring of change with time or the like is performed in a long term, it is necessary to supply electric power (supply of electric power) to the sensors 18. As countermeasures in this case, supply of electric power using an MEMS oscillation power generator, wireless power supply (non-contact power supply) of transmitting electric power using an induced magnetic flux generated between a transmitting side and a receiving side in an electromagnetic induction system, photovoltaic power generation, wired-LAN power supply using a LAN cable, and the like are conceivable.

As described above, with the shape acquisition method according to the embodiment, it is possible to accurately acquire a shape of a surface (a measurement surface) on which measurement points are arranged of a target object (wall), that is, an in-plane distribution of amounts of deformation of the target object (wall) by fitting information of discrete tilt angles at a plurality of measurement points of the target object (wall) acquired by a plurality of sensors 18 two-dimensionally installed on the target object (wall) or discrete information of heights of the measurement points from the reference plane calculated on the basis of the information of the tilt angles to a predetermined function. Accordingly, even when the target object is an earth retaining wall, it is possible to calculate information of an amount of protrusion (a height z) of a point other than the points at which the sensors 18 are installed without performing proportional calculation. Particularly, when function fitting is performed using an orthogonal polynomial such as the Zernike polynomial z=W(ρ, θ) described above in the embodiment, it is possible to numerically calculate the most protruded position (ρ, θ) and the amount of protrusion from the orthogonal polynomial.

Here, it is conceivable that measurement of a shape of a measurement surface with the same accuracy as in a case in which the function fitting according to the embodiment is performed be realized, for example, using the method described in Patent Document 1. In this case, it is apparent that much more tilt sensors than those in the embodiment are necessary, and it can be said to be a nonrealistic method in view of costs required for acquisition, installation, and the like of the plurality of sensors.

As can be seen therefrom, with the shape acquisition method according to the embodiment, it is possible to accurately perform areal evaluation of measurement management of a target object such as an earth retaining wall at low costs.

An orthogonal polynomial which can be suitably used for the function fitting is not limited to a Zernike polynomial, and may be a Fourier series, a Chebyshev polynomial, a Legendre polynomial, or the like.

In the embodiment, an example in which identification information is input using the display and operation unit 187 at the time of initial setting of the sensors 18ᵢⱼ has been described, but timings, methods, and the like of inputting the identification information to the sensors 18 (or storage in the RAM (memory)) are not particularly limited and the sensors 18 used in the embodiment preferably output data including identification codes (IDs) of the sensors 18. In the embodiment, the identification codes (IDs) of the sensors 18 include identification codes of target objects to which the sensors 18 are installed and identification codes of the installation positions on the target objects, but may not include the identification codes of the target objects.

In the embodiment, it is assumed that the target object is a soil-cement column-array wall, but the target object may be a steel sheet pile wall, a soldier-pile horizontal sheathing wall, a steel pipe sheet pile wall, or another earth retaining wall. In the embodiment, when the target object is an earth retaining wall, calculation of a shape thereof, deformation management of the earth retaining wall due to ground water or the like using the calculated shape, management of change with time, and the like are described above, but the shape acquisition method and the shape acquisition system according to the embodiment (hereinafter referred to as a method and a system according to the embodiment) can be suitably applied to various target objects. They can be applied to management of a steel frame (management of absolute values and management of change with time) and other construction process management. The target object may be another infrastructure such as a bridge, a dam, a tunnel, a highway, or a plant (which includes a tank), or may be a windmill vane (blade) for wind power generation, a body, a wing, or a propeller of an aircraft, a vehicle body (particularly, a leading vehicle)) of a high-speed railway (such as the Shinkansen), a railway rail, a rail of a monorail (a straddle type or a suspended type), a ship, a screw thereof, or the like. In addition, the target object may be a vehicle (such as an automobile including an F1 car, an aircraft, a railway, or a ship), an underwater vehicle (such as a submarine or a deep-submergence vehicle), a space-relevant structure (such as a space ship or a re-entry body), a flying object (such as a rocket, a missile, or a satellite), a power plant (such as a hydroelectric power plant, a thermoelectric power plant, a natural-gas power plant, or a nuclear power plant), or the like. The target object (a measurement object for the sensor devices) can be, for example, a part or a constituent member of an infrastructure structure, a vehicle, or another mobile object. Examples of the infrastructure structure include a theater, a viewing site, a public hall, a lecture hall, a concert hall, a traditional art hall, an entertainment hall, a movie theater, an international conference arena, a cultural hall, a civic center, a multi-purpose hall, a public meeting place, a library, an art museum, a museum, a data library, an aquarium, an indoor pool, an indoor facility such as facilities for ball games or other indoor sports, and an outdoor facility such as a stadium (which includes an athletic field, a baseball park, and a soccer field). The measurement object is a ceiling of an indoor facility or the like and is a roof covering guest seats in an outdoor facility. Similarly to a case in which the aforementioned earth retaining wall or a tunnel which will be described later is used as a target object (a measurement object), measurement according to the embodiment may be performed at the time of construction of an infrastructure structure, or measurement of deformation of the measurement object may be performed after the construction has been completed.

An example of construction process management which can be suitably applied to the method and system according to the embodiment is management of piling (management of an absolute value or management of change with time). Here, a pile means a structure serving as a foundation at the time of construction.

The method and system according to the embodiment can also be applied to infrastructure management. The method and system according to the embodiment can be suitably applied to, for example, maintenance of a bridge (management of change with time), management of bridge construction (management of an absolute value), maintenance of a dam wall (management of change with time), maintenance of a tunnel (management of change with time), and maintenance of a plant/gas tank (management of change with time). In addition, the method and system according to the embodiment can also be applied to various types of deformation analysis. For example, the method and system according to the embodiment can be suitably applied to deformation analysis (change with time) of the bottom of a ship, deformation analysis (change with time) of a wind power generation vane, deformation analysis (change with time) of a drone wing, or deformation analysis (change with time) of a railroad rail.

When the method and system according to the embodiment is applied to maintenance of a bridge, for example, a plurality of sensors 18 are installed on the bridge, change of a three-dimensional shape from an initial state is normally monitored, and, for example, a warning is issued from the server 12 to the field-side computer 14, for example, when an index indicating change of the shape (for example, a tilt angle or a maximum deformation output from the sensors 18) is greater than a threshold value. With this configuration, since a manager of the field-side computer 14 can rapidly recognize occurrence of an abnormality and an occurrence position, it is possible to realize efficient visual inspection.

Particularly, in maintenance of a bridge such as a suspended bridge, it is possible to realize automated adjustment of a bridge girder shape by improving the techniques described above in optimal support of a target object (wall) using struts. Specifically, at the time of initial adjustment of the bridge, the dedicated database (the matrix Q) is prepared by replacing an axial force for a strut with a tension of a cable of a suspended bridge. Thereafter, automated adjustment of the bridge girder shape is performed at predetermined intervals as follows.

That is, a surface shape (a deformation distribution) W of the bridge girder represented by the polynomial of Expression (4) or Expression (9) is calculated using the first method or the second method. Data of a column matrix (that is, a vertical vector) Q′ of Expression (12) is acquired in the same way as described in Step S226.

By solving the relationship of Expression (13) established among the matrix Q′, the matrix O, and adjustment values of tensions of a plurality of cables (which are represented by the same column matrix P as in Expression (14)) using a least square method as described above, elements of the matrix P, that is, optimal adjustment values of the tensions of the plurality of cables, are calculated, and the tensions for the plurality of cables are adjusted on the basis of the acquired optimal adjustment values.

For some target objects, it is also conceivable that arrangement of bearing members that can most efficiently bear a target object be found by preparing a plurality of dedicated databases the same as the matrix O while changing positions of the bearing members through simulation and comparing the prepared plurality of dedicated databases.

### <<Modified Example of Measurement of Deformation of Tunnel Inner Space Surface>>

At the time of constructing or managing a structure of civil engineering or construction (hereinafter also referred to as a structure), displacement with time of a surface of a nearby variable natural ground, the ground, and a surface of another natural object or artificial object (hereinafter also referred to as a variation surface) may be measured in order to ascertain stability and safety and to evaluate appropriateness of a design and construction thereof. For example, when a mountain tunnel is excavated, necessary timbering or primary lining is set up in a working place immediately after the excavation, and tunnel A measurement is performed to ascertain behavior of a nearby natural ground or deformation of timbering and to determine safety of the construction and appropriateness of the timbering. Tunnel A measurement is construction management of continuously measuring displacement of a tunnel inner space surface (a variation surface) in a rear base separated from the working place. When a displacement rate of the tunnel inner space surface (the variation surface) converges on a predetermined value or less (for example, 1 mm/week or less), the nearby natural ground is determined to be stabilized, and a secondary lining serving as a final tunnel surface is installed on an inner space surface after the displacement has converged.

In tunnel A measurement according to the related art, three-dimensional coordinates and displacement of measurement points with respect to an observation point are measured, for example, by providing measurement points at predetermined positions (total 3 to 5 points) such as a top end position, a shoulder position, and a leg position which are sectional positions separated a predetermined distance from the working place, installing a target (a reflecting film or a prism) is installed at each measurement point, sequentially collimating the targets with a total station (a three-dimensional electronic distance meter), and calculating a horizontal angle, a vertical angle, and a distance.

In this method, since the number of measurement points for each tunnel inner space (sectional surface) is limited to three to five points, it is difficult to ascertain detailed change of a shape of the sectional surface. Accordingly, a target is installed at three or more existing positions (positions in the global coordinate system which are also referred to as tunnel coordinate values) on a tunnel inner space surface (a variation surface), the inner space surface including the targets is scanned using a three-dimensional laser scanner (hereinafter also referred to as a scanner device) to acquire three-dimensional coordinate values of a plurality of measurement points (positions in the coordinate system of the scanner device which are also referred to as scan coordinate values), and then the positions of the targets are detected out of the measurement points. Here, by forming each target out of a high-reflection sheet (a total-reflection sheet) or an absorption sheet (a low-reflection sheet) for a laser beam, the positions of the targets are detected as data-missed areas out of a plurality of measurement points, and scan coordinate values thereof are identified. Subsequently, scan coordinate values of other measurement points are converted to tunnel coordinate values on the basis of a relationship between the scan coordinate value of the identified target and the tunnel coordinate value thereof, and a sectional shape of the tunnel inner space surface is measured on the basis of the tunnel coordinate values of the measurement points after the conversion. With this method, it is possible to ascertain detailed shape change of a variation surface by continuously measuring the shape of the variation surface such as the tunnel inner space surface and sequentially comparing the measured shapes.

In this modified example, measurement of the shape and the shape change of the tunnel inner space surface (the variation surface) is performed using the method and system according to the embodiment. That is, it is possible to monitor change with time of the tunnel inner space surface (the variation surface) by installing a plurality of sensors 18 in the almost whole range of a predetermined area of the tunnel inner space surface (the variation surface) and performing measurement of a shape of the tunnel inner space surface (the variation surface) at a plurality of time points using the plurality of sensors 18 with the tunnel inner space surface as a measurement surface similarly to the aforementioned earth retaining wall. In this case, it is possible to obtain the same advantages as when the three-dimensional laser scanner is used. In addition, in this modified example, since tilt angles at the measurement points are measured using the plurality of sensors 18 installed on the tunnel inner space surface, it is possible to monitor change of the tilt angles (position information) at the same point (measurement point). On the other hand, when a three-dimensional laser scanner is used, laser beams from the three-dimensional laser scanner are applied to different measurement points at every time of measurement, and thus it is difficult to measure change of the position information at the same measurement point. When a three-dimensional laser scanner is used, the three-dimensional laser scanner may need to be installed again on a batholith in a rear base separated from the working place of the tunnel at every time of measurement. On the other hand, according to this modified example, it is possible to monitor change of a shape of the tunnel inner space surface by installing a plurality of sensors 18 in predetermined areas on the tunnel inner space surface (the variation surface) and only repeatedly performing acquisition of output data from the plurality of sensors 18 and predetermined arithmetic using the output data. Behavior of a nearby natural ground or deformation of timbering is ascertained on the basis of the result of monitoring. Accordingly, it is possible to rapidly take necessary measures. At this time, a deformation distribution in an area may be calculated, for example, on the basis of the Zernike mode map and magnitudes of coefficients of terms of Zernike components.

In this modified example, since the shape and the shape change of the tunnel inner space surface (the variation surface) are measured using the method and system according to the embodiment, it is possible to substantially perform the tunnel A measurement of continuously measuring a displacement of the inner space surface by measuring the shape change of the inner space surface according to this modified example after necessary timbering and primary lining have been set up in the working place after the excavation, and it is possible to determine whether a displacement rate converges on a predetermined value or less (for example, 1 mm/week or less). That is, it is possible to determine whether to start installation of secondary lining on the inner space surface on the basis of the result of measurement of the shape of the inner space surface acquired at a plurality of time points. Determination of whether the displacement rate converges on the predetermined value or less (for example, 1 mm/week or less), that is, determination of whether to start installation of secondary lining on the inner space surface, is performed by the server 12. In this case, when the sensors 18 are installed in steel timbering, shape measurement of an area of the tunnel inner space surface including the steel timbering can be started after the steel timbering has been set up, and thus it is possible to early determine appropriateness of the steel timbering. When it is determined that the steel timbering is unstable, it is possible to take measures such as additional installation of lock bolts or the like. When tunnel A measurement is performed using a total station, it is necessary to predict a final amount of displacement from an initial displacement rate in the tunnel A measurement on the basis of pre-acquired correlation data between the initial displacement rate and the final amount of deformation, but such prediction is not necessary in this modified example. The correlation data is acquired, for example, from results of storage of the initial displacement rate and the final amount of deformation in the tunnel A measurement, but this storage is also not necessary in this modified example.

### <<Modified Example of Shape Measurement of Floor Surface of Factory or Warehouse or the Like>>

In this modified example, the method and system according to the embodiment is applied to an automated warehouse, a factory of a manufacturer of vehicles, or the like.

An article storage facility is provided in a part of an automated warehouse, a factory of a manufacturer of vehicles, or the like. The article storage facility includes a carrier unit for carrying, for example, a container (vessel) formed of plastic for accommodating components or the like used in a manufacturing line and a control unit for controlling the carrier unit. A building in which the article storage facility is provided is configured such that a container group having a plurality of containers stacked is placed and stored at a plurality of positions on a placement surface (floor surface) constituting the storage area. A carrier device including a grasp part that is movable in three-axis directions including two-axis directions (an X-axis direction and a Y-axis direction) in a horizontal plane (an XY plane) which is a virtual plane substantially parallel to the placement surface and a direction (a Z-axis direction) perpendicular to the horizontal plane can be used as the carrier unit. The grasp part includes a plurality of grasp units that can approach or separate from the containers in a plurality of directions and grasp the containers.

Therefore, a plurality of sensors 18 are installed in almost the whole range of a predetermined area on the placement surface (the floor surface), a shape of the placement surface (the variation surface) is acquired in the same ways as in the aforementioned earth retaining wall using the plurality of sensors 18, and grasp positions of a container grasped by the grasp part can be adjusted by causing the control unit to control the carrier unit using the measurement results. In this case, the control unit has the same function as the server 12.

Here, the carrier unit carrying a container (a vessel) may be constituted, for example, by a robot having a robot hand that is movable in at least three-axis directions (Y, Y, and Z) perpendicular to each other. One or more manufacturing lines are provided in some buildings in the factory, and, for example, robots for picking up components are provided in the manufacturing lines. In this case, grasp positions of containers or pickup positions of components by the robot hand are adjusted by the control unit on the basis of the results of measurement of the shape of the placement surface (the variation surface) of the buildings. In any case, a position of the robot hand (a tip position of a robot) is adjusted.

This modified example can be employed even when a line in the factory is added or changed as well as when an automated warehouse, a factory of a manufacturer of vehicles, or the like is newly installed, and it is possible to set or reset (modify) the grasp positions of containers by the grasp part of the carrier unit or the tip position of the robot.

As can be seen from the aforementioned description, with the shape acquisition method and the shape acquisition system according to the embodiment, a work support method and a work support system including acquiring shape information of a target object using the aforementioned shape acquisition method and performing at least one of detection of an abnormality in the target object, determination of a bearing force of a bearing member supporting the target object, and preparation/proposal of a work procedure can be easily realized as a work support method of supporting object construction work. In this case, the server 12 also serving as an analysis device performs at least one of detection of an abnormality in the target object, determination of a bearing force of a bearing member supporting the target object, and preparation/proposal of a work procedure on the basis of the shape information. Particularly, when the target object is an earth retaining wall such as a wall 22, an abnormality to be sensed includes flowage. In this case, the bearing force of the bearing member corresponds to the axial force of the corresponding strut 54. An example of preparation/proposal of a work procedure is setting/resetting the grasp position of a container by the grasp part of the carrier device or the tip position of the robot described above in the example of the article storage facility.

A manager of the server 12 is not particularly limited as long as the manager of the server 12 shares design data of a structure including a target object (an earth retaining wall in the embodiment) in which the sensors 18 are installed or the like with a manager of the field-side computer 14. For example, the server 12 may be managed by a user of the sensors 18 such as a construction company or may be managed by a supply company (such as a manufacturer or a supplier) of the sensors 18. The server 12 may be a cloud computer. When the server 12 is managed by the supply company of the sensors 18, the supply company leases (or rents) the sensors 18 to a user and provides optimal information such as installation positions of the sensors 18 which are determined on the basis of a pre-acquired purpose of use. The supply company is supplied with data acquired from the sensors 18 by the user on the basis of the information, performs predetermined analysis (which includes shape calculation) using the data, and provides information of the analysis result to the user. Then, the supply company receives rewards of lease (or rental) of the sensors 18 and provision of information from the user. It is possible to realize such a business method (a business model). In this case, instead of analysis and provision of the analysis result, application software for analysis processing (an application program) may be leased along with the sensors 18.

In the embodiment, a fitting process based on an arithmetic operation using data acquired through measurement by the sensors 18 has been described above, but the present invention is not limited thereto and component decomposition of fitting can be applied to data not based on the sensors 18. The component decomposition of fitting can be used for results acquired from other measuring instruments or deformation analysis results from a CAD or the like. It can also be used for 3D shape data in addition to an uneven shape of a plane. It is considered to be applied to data not associated with a shape such as temperature distribution data, sound distribution data, or the like.

### REFERENCE SIGNS LIST

10 Shape acquisition system
12 Server
13 Network
16 Mobile terminal
18 Sensor device
22 Soil-cement column-array wall
181 Angle sensor
182 Arithmetic processing unit
183 Communication unit
184 Power supply unit
185 Housing
187 Display and operation unit

What is claimed is:

1. A shape acquisition method of acquiring shape information of a target object, the shape acquisition method comprising:
acquiring information of a tilt angle of a measurement surface of the target object at a plurality of measurement points using a plurality of sensor devices respectively, positions of the measurement points being different in one of two directions crossing each other in the measurement surface; and
acquiring a shape of the measurement surface represented by a predetermined polynomial function as the shape information of the target object, the polynomial function including coefficients of terms calculated by fitting a discrete distribution of a physical quantity associated with the tilt angle calculated on the basis of the acquired information of the tilt angle at the plurality of measurement points and position information of the plurality of measurement points to the polynomial function.

2. The shape acquisition method according to claim 1, wherein the physical quantity is a gradient of a tangent plane to the measurement surface at each of the plurality of measurement points.

3. The shape acquisition method according to claim 1, wherein the polynomial function used for the fitting is a function which is acquired by differentiating an orthogonal polynomial.

4. The shape acquisition method according to claim 3, wherein the polynomial function used for the fitting is a differential Zernike polynomial which is acquired by differentiating a Zernike polynomial.

5. The shape acquisition method according to claim 3, wherein the polynomial function including the calculated coefficients as definitive coefficients of the terms is an orthogonal polynomial which is acquired by integrating a function acquired through the fitting.

6. The shape acquisition method according to claim 1, wherein the discrete distribution of a physical quantity is an in-plane distribution of an amount of separation of the measurement surface from a reference plane at each of the plurality of measurement points.

7. The shape acquisition method according to claim 6, wherein the polynomial function used for the fitting is an orthogonal polynomial.

8. The shape acquisition method according to claim 1, wherein at least one surface of the target object is used as the measurement surface and the tilt angle of the measurement surface at the plurality of measurement points on the measurement surface is able to be measured using the plurality of sensor devices.

9. The shape acquisition method according to claim 1, wherein the target object is a part or a constituent member of an infrastructure, or a mobile object including a vehicle.

10. An object management method comprising:
repeatedly performing the shape acquisition method according to claim 1; and
monitoring change of a shape of the target object with time on the basis of the shape information acquired whenever the shape acquisition method is performed.

11. An object management method comprising:
performing the shape acquisition method according to claim 1 at a first time point and a second time point later than the first time point; and
identifying a position at which an amount of deformation of the measurement surface of the target object is greater than a predetermined allowable value on the basis of amounts of change of the coefficients of the terms of the polynomial function acquired at the time points.

12. The object management method according to claim 11, wherein the polynomial function representing the shape of the measurement surface is a Zernike polynomial, and
wherein the position at which an amount of deformation of the measurement surface of the target object is greater than a predetermined allowable value is identified on the basis of the amounts of change of the coefficients of the terms in the Zernike polynomial acquired at the time points and a Zernike mode map.

13. The object management method according to claim 11, wherein the target object is an earth retaining wall, and values of axial forces to be individually applied to a plurality of struts for supporting the earth retaining wall are determined on the basis of information of the identified position and a magnitude of an amount of deformation at each position.

14. The object management method according to claim 11, wherein the target object is an earth retaining wall, and an excavation position on the rear side of the earth retaining wall is determined while maintaining axial forces to be applied to a plurality of struts for supporting the earth retaining wall on the basis of information of the identified position and a magnitude of an amount of deformation at each position.

15. The object management method according to claim 10,
wherein the target object is a tunnel, and the measurement surface is an inner space surface of the tunnel, and
wherein behavior of a nearby natural ground or timbering deformation is ascertained on the basis of the monitoring result.

16. The object management method according to claim 10, wherein a warning is issued when the monitored change of the shape of the target object is greater than a threshold value.

17. The object management method according to claim 11,
wherein the target includes an infrastructure structure, and
wherein the shape of the target object is monitored at at least one of the timings of (a) while the infrastructure structure is constructed and (b) after the construction of the infrastructure structure.

18. A work support method of supporting object construction work, the work support method comprising:
acquiring shape information of a measurement surface of a target object at one or more time points including a first time point using the shape acquisition method according to claim 1; and
performing at least one of sensing an abnormality in the target object, determining a bearing force of a support member supporting the target object, and preparing/proposing a work procedure on the basis of the acquired shape information.

19. The work support method according to claim 18, wherein the target object is an earth retaining wall,
wherein the sensing of an abnormality includes sensing flowage, and
wherein the bearing force of the support member includes an axial force of a strut.

20. The work support method according to claim 18, wherein the target object is an automated warehouse or a factory of a manufacturer and the measurement surface is a floor surface of a building in which an article storage container/manufacturing line is provided, and
wherein a grasp position of a container or a tip position of a robot is set/reset using the acquired measurement result of a shape of the floor surface.

21. The work support method according to claim 18, wherein the target object is a tunnel, and the measurement surface is an inner space surface of the tunnel, and
wherein behavior of a nearby natural ground or timbering deformation is ascertained using the acquired measurement result of a shape of the inner space surface.

22. The work support method according to claim 21, further comprising determining whether installation of a secondary lining on the inner space surface is to be started on the basis of the measurement result of the shape of the inner space surface acquired at a plurality of time points.

23-48. (canceled)
